(19) United States
(12) Patent Application Publication
(10) Pub. No.: US 2022/0164835 A1
(43) Pub. Date: May 26, 2022

(54) SYSTEM FOR MANAGING DISPLAY LOCATION AND INVENTORY OF PRODUCT BY USING CLUSTERED RELATED SEARCH WORDS

(71) Applicant: Kwon Suk KOH, Songpa-gu, Seoul (KR)

(72) Inventor: Kwon Suk KOH, Songpa-gu, Seoul (KR)

(21) Appl. No.: 17/310,617

(22) PCT Filed: Mar. 2, 2020
(86) PCT No.: PCT/KR2020/002964

§ 371 Date: Aug. 13, 2021

(30) Foreign Application Priority Data
Mar. 4, 2019 (KR) 10-2019-0024809

(51) Int. Cl. G06Q 30/02; G06Q 30/06; G06F 16/33

(52) U.S. Cl. CPC G06Q 30/0281; G06F 16/3334; G06Q 30/0639; G06Q 30/0625

(57) ABSTRACT

The display position and inventory management system of the product using the bundle-related search words according to an embodiment of the present invention includes the following; customer terminal searching for goods displayed in the store using a store product search platform that uses bundle-related search words as product keywords; product management terminal to register, search and manage product's display location, shelf number, product name, total inventory for each product and goods images in store based on product identification number and the bundle-related search words: and the product information in the store is converted into a database, and store management server providing at least one of the product's display position, shelf number, product name, total inventory for each product, and product images to the store product search platform and product management terminal corresponding to the search information entered in the store product search platform and product management terminal.

### TECHNICAL FIELD

The present invention relates to a display position and inventory management system of goods using bundle-related search words.

### BACKGROUND

It is not easy to find the products people want in large stores.

Conventionally, consumers should find and inquire store managers or staff directly. It would be expensive for store staff to individually guide customers to the product they want.

### DETAILED DESCRIPTION OF THE INVENTION

### Technical Challenge

The problem to be solved by the present invention relates to a display position and inventory management system of goods using the bundle-related search words that can solve the conventional problems.

### Solution to Problem

The display position and inventory management system of the product using a bundle-related search word according to an embodiment of the present invention for solving the above problem includes the following: Customer terminal searching for goods displayed in the store using a store product search platform that uses bundle-related search words as product keywords; product management terminal to register, search and manage product's display location, shelf number, product name, total inventory for each product and goods images in store based on product's identification number and the bundle-related search words: and the product information in the store is converted into a database, and store management server providing at least one of the product's display position, shelf number, product name, total inventory for each product, and product images to the store product search platform and product management terminal corresponding to the search information entered in the store product search platform and product management terminal.

In one embodiment, the product management terminal includes the following. A scan unit scanning product display rack or product identification number; first indicate unit for indicating the scanned identification number; second indicate unit for indicating the product name and quantity of goods registered with the scanned identification number; search word input unit to input related search words of product as text or voice; an input/output unit for requesting at least one or more information among the shelf number on which the product was displayed, product name, total inventory, product image and shelf location, and receiving feedback information from management server corresponding to an identification number or bundle-related search words; and third indicate unit for indicating shelf number, product name, total inventory, product images and a shelf location on which the product corresponding to the bundle-related search word inputted to the input unit is displayed.

In one embodiment, the product management terminal includes the following. Scan action button that provides ON/OFF operation signal of the scan unit; reset button provides a reset signal; and action switch button for changing the action of the search word input unit to any one of the text, voice and manual modes. The reset signal may be a signal for resetting the action of the first indicate unit, second indicate unit, third indicate unit and scan unit.

In one embodiment, includes the following. Speech to text unit with program installed including speech to text (STT) engine for converting speech information into text. The speech to text unit includes the following. Extraction unit for extracting the code of the converted text (word) from the already set code table of bundled word; Text code array unit that lists the extracted words in a pattern structure of bundle-related search words

In one embodiment, includes an AI agent that provides feedback voices of voice queries from store customers or managers and the AI agent includes multilingual language support.

In one embodiment, store product search platform includes the following. A scan interface for scanning the electronic identification code of the product linked with the camera of the customer terminal; a product information search interface for searching for displayed products, product's display location and a shelf number in store using bundle-related search words; a product information registration management interface for generating and providing a product list script for registering and managing products list input by a customer; a shopping route interface that creates and displays the shortest-distance shopping route line of the store to the customer based on the product list registered in the product information registration management interface.

In one embodiment, the product information registration management interface includes a product list sharing function for sharing a product list with an acquaintance terminal, and combining the product list of acquaintance terminal in my product list, and filtering function to filter duplicate products in the shared product list.

In one embodiment, the product information registration management interface may be characterized by subtracting a product scanned from the scan interface in the product list among the products in the registered product list.

In one embodiment, the product information search interface may be characterized by providing a bundle-related search table in which the bundle-related search words corresponding to the products displayed in the store are arranged.

In one embodiment, the store product search platform includes a product purchase history management interface for recording and storing a purchase history of a product included in the registered product list and a purchase history of the purchased product.

In one embodiment, store management server includes the following. Product management unit that registers, deletes and changes the product information input in the store management terminal, and manages total quantity, inventory, order, return and damage by each product; the product search unit providing a search result of searching for a display location, a shelf number, and a stock of product corresponding to a bundled search keyword entered in the store management terminal and the store product search platform; the store management unit that manages store area information including location information of product display rack and location information of equipment in the store; the search keyword providing unit for generating and providing a bundled search keyword of goods displayed in a store; and platform service unit that supports the scanning function of the store product search platform, product information search interface, product information registration management function, shopping route function, product list sharing function, duplicate product filtering function, and product purchase history management function.

In one embodiment, the bundle-related search words include the following. A first search factor that bind with the origin (country) of the product to be searched, the product name used in the origin and standard word; and second search factor for classifying into any one of the large, medium, and small categories of the product.

### Effects of the Invention

Shelf product management scan terminal using the bundle-related search words linked to the store management server according to an embodiment of the present invention may provide the location information of goods displayed in store and the shelf on which the product is displayed.

One embodiment of the present invention can guide the product location from the current location, and can shorten the time it takes to find a product that customers want in a store.

### BRIEF DESCRIPTION OF THE DRAWINGS

FIG. 1 is a block diagram of a display position and inventory management system of the product using the bundle-related search words according to an embodiment of the present invention.

FIG. 2 is an exemplary view for explaining the function of the product information search platform installed in the customer terminal shown in FIG. 1.

FIG. 3 is an exemplary diagram of a product management terminal of FIG. 1.

FIG. 4 is a block diagram of the product management terminal shown in FIG. 1.

FIG. 5 is a block diagram of the store management server shown in FIG. 1.

### BEST MODE FOR CARRYING OUT THE INVENTION

Exemplary embodiments of the present invention will be described in detail with reference to the accompanying drawings so that those skilled in the art may easily practice the present invention. The invention can be implemented in many different forms, and it is also not limited to the embodiments described herein.

It is noted that the figures are schematic and not drawn to scale. The relative dimensions and ratios of the parts in the figures have been exaggerated or reduced in size for clarity and convenience in the figures, and any dimension is merely exemplary and not limiting. The same structures, elements or parts that appear in more than two figures are used to refer to similar features by like reference numerals.

Embodiments of the present invention specifically illustrate ideal embodiments of the present invention. As a result, various modifications of the drawings are expected. Therefore, the embodiment is not limited to the specific form of the illustrated region, for example, includes variations of form by manufacture.

On the basis of the accompanying drawings will be described in more detail the display position and inventory management system of the goods using the bundle-related search words according to an embodiment of the present invention.

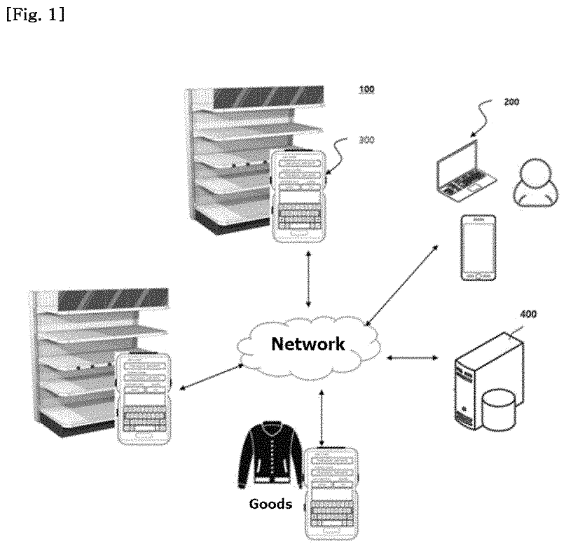

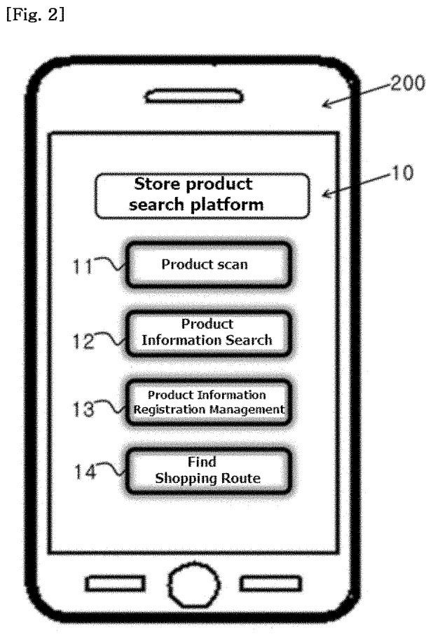

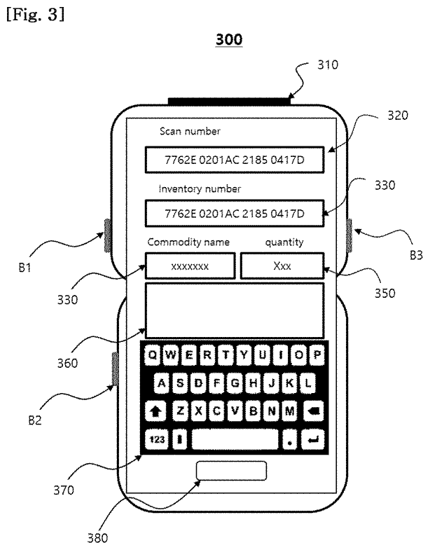

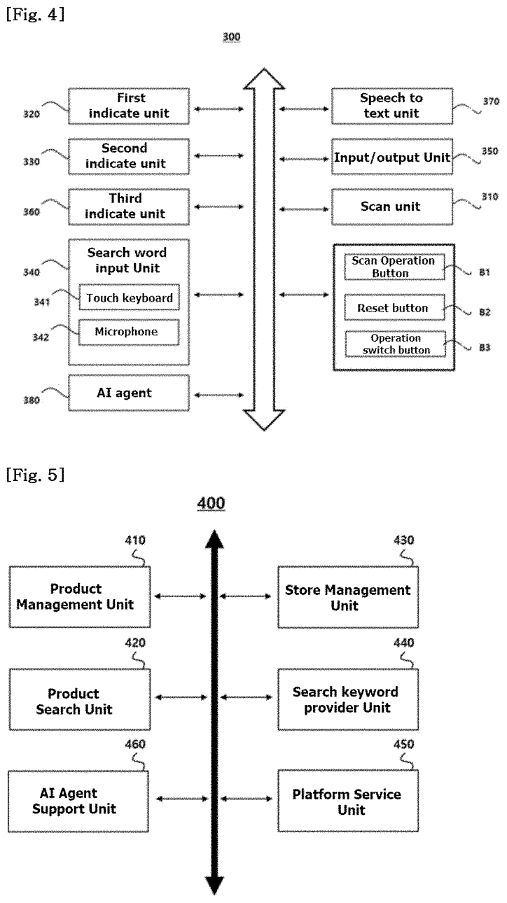

FIG. 1 is a block diagram of a display position and inventory management system of the product using the bundle-related search words according to an embodiment of the present invention. FIG. 2 is an exemplary view for explaining the function of the product information search platform installed in the customer terminal shown in FIG. 1. FIG. 3 is an exemplary diagram of a product management terminal of FIG. 1. FIG. 4 is a block diagram of the product management terminal shown in FIG. 1. FIG. 5 is a block diagram of the store management server shown in FIG. 1.

As shown in FIG. 1, display position and inventory management system (100) of product using a bundle-related search word according to an embodiment of the present invention may include a customer terminal (200), product management terminal (300), and store management server (400).

The customer terminal (200) and the product management terminal (300) can communicate with the store management server (400) through the network.

the network refers to a connection structure in which information exchange is possible between each node such as a plurality of terminals and servers, and examples of such networks include the following, but are not limited to. RF, 3GPP (3rd Generation Partnership Project) network, LTE (Long Term Evolution) network, 5GPP (5rd Generation Partnership Project) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, NFC network, Satellite broadcasting network, analog broadcasting network, DMB (Digital Multimedia Broadcasting) network and etc.

The customer terminal (200) may be a terminal on which a product information search platform (10) installed for searching for products displayed in a store designated by the customer.

The customer terminal (200) may be implemented as a computer that can access a remote server or terminal through a network. The computer may include, for example, notebook, desktop, laptop and etc. installed with navigation and web browser. The lease terminal (100) may be implemented as a terminal that can access a server or terminal of remote area through a network. For example, the lease terminal (100) is a wireless communication device that guarantees portability and mobility, and wireless communication devices can include as follows all types of handheld-based; Navigation, PCS (Personal Communication System), GSM (Global System for Mobile communications), PDC (Personal Digital Cellular), PHS (Personal Handy phone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, Smartphone, smart pad, Tablet PC, and etc.

See FIG. 2, the product information search platform (10) may be provided from a store management server (400), and may be platform including an application, program, web page, etc. installed or driven in a customer terminal through a network.

Web browser as a program that enables web (WWW) services is a program that receives and displays hypertext described in HTL, and includes Netscape, Explorer, Chrome, etc.

Application means an application program on the terminal, and includes an app running on a mobile terminal (Smartphone). The app can be downloaded and installed from the application market which is virtual marketplace for freely buying and selling mobile content.

The product information search platform (10) may include a scan interface (11), a product information search interface (12), a product information registration management interface (13) and shopping route interface (14).

The scan interface (11) is performed a function of scanning the electronic identification code of the product linked with the camera of the customer terminal.

The product information search interface may be an interface for searching for a displayed position and display number of displayed and/or received product in a corresponding store using bundle-related search words in a store designated by a customer.

The product information search interface may provide bundle-related search table in which the bundle-related search words are arranged corresponding to the products displayed in store.

The product information registration management interface may be an interface for registering and managing a list of products input by a customer. The product information registration management interface may classify the products registered by the customer based on the product type or the order of shelves number on which the products are displayed.

The product information registration management interface may include a product list sharing function for sharing a product list registered in another customer's terminal. The product list sharing function can add the product list provided by the terminal of the other customers and the product list registered by the customer himself, and can be filtered in the case of duplicated product list.

Assume that the first customer terminal and the second customer terminal share a product list as follows. If product lists provided by the first customer terminal are 30 product's name and product lists registered on the terminal of the second customer are 10 product's name and duplicated products are 10 product's name, the products number added to the second customer terminal are 30 product's name.

The product information registration management interface may perform a function of subtracting a product scanned from the scan interface among the products in the registered product list from the product list.

The shopping route interface (14) is linked with the product information registration management interface (13), and provides the ability to create and display the shortest shopping route for product purchase after extracting the shelves location (number) of the products included in the product list registered in the product information registration management interface (13).

Store product search platform (10) according to an embodiment of the present invention may further include purchase history of a product included in a registered product list, and a product purchase history management interface for recording and storing a purchase history of the purchased product.

Referring to FIGS. 3 and 4, when displaying products in a store, a product management terminal (300) is used to identify the shelves location and the products name, and to arrange the products on different shelves, and provides the function of product location confirmation, product location change and product management query by the product manager, and may be a terminal for helping to easily find the location confirmation of product that store customers want to purchase and the location of the shelf on which the product is placed.

More specifically, the product management terminal (300) according to an embodiment of the present invention may includes can unit (310), the first indicate unit (320), the second indicate unit (330), the search word input unit (340), the input/output unit (350), the third indicate unit (360), and speech to text unit (370).

Also may include scan action button (B1) for providing an ON/OFF action signal of the scanning unit (310), and the screen of the first indicate unit (320), the second indicate unit (330) and the third indicate unit (360), and reset button (B2) for providing a signal for resetting action of the scan unit (310), and action switch button (B3) for the action switch (Switch from voice input to text input or from text input to voice input (manual conversion)) of the search word input unit (340).

The scan unit (310) provides extraction information obtained by extracting text and numbers in the scanned image to the first display unit (320) and the second display unit (330) after scanning the product identification code (tag or first dimensional barcode) and the identification code (ID tag) of product display racks.

The scan unit (310) is turned “ON and OFF” through the action signal of the above-described scan action button (B1). The user may activate and deactivate an action of the scan unit by using the scan action button.

The first display unit (320) displays the identification number on the scan unit (310).

The second indicate unit (330) displays a product name and a quantity of goods registered with the identification number scanned by the scan unit (310).

The second indicate unit (330) displays a name and a quantity of a product corresponding to the bundle-related search words input by text or voice in the search word input unit (340) to be described later.

The search word input unit (340) may input bundle-related search words of product as text or voice.

The search word input unit (340) can include a touch keyboard (141) and a microphone (342). The voice information input to the microphone (342) is provided to the speech to text unit (370) to be described later, and the speech to text unit (370) provides the conversion information obtained by converting the voice into text to the third indicate unit (360) to be described later, and the third display unit (360) displays the conversion information.

The search word input unit (340) may receive bundle-related search words of text or voice.

The pattern of the bundle-related search words has a pattern structure in which at least one or more search factors are sequentially arranged.

The first search factor may be a search factor that refer to a standard words (including a product name) of a product to be searched.

For example, if the first search factor is marked as ‘rise.de.rice’, ‘rise’ is a rice in German, ‘de’ is an abbreviation for ‘German’, and ‘rice’ is a English name and standard words of a rice.

The second search factor as a factor for classifying product classification is classified in large category of code A:, middle category of code B:, small category of code C: and . . . .

The large category is grain (vegetables, fruits, etc.), the medium category is rice (barley, wheat, sorghum, etc.), the small category is white rice (brown rice, black rice, glutinous rice, etc.), and the brand name may be Icheon rice, Gyeonggi rice, and etc.

Large, middle, small category and product names may be represented by codes in the form of numbers and alphabets. For example, it may be represented as grains (A01), vegetables (A02), rice (B01), barley (B02).

Rice of grain may be labeled A01..B01, and barley of grain may be labeled A01.B02.

An example of a plant is given above, but it can be applied to all existing products. Subclassification can be expanded or reduced depending on the type of product.

The composition of the bundle-related search words proposed in the present invention includes the following. Words of large, medium, and small categories related to one product, synonyms and dialects of a product name, and sentences that express the product in sentences, and all words and sentences that have been translated can be the target.

The composition of the bundle-related search words mean all “the shelves of same number”, the goal is to show the same display shelf number when 100 customers input the name of same product as 100 different languages.

By entering the above-described search factors in text or voice product, manager and the store customer can easily find the location of the product, and the location information of the shelf on which the product is displayed they are looking for, and can easily able to display of goods.

The input/output (350) unit requests at least one or more information of display rack number, product name, total inventory, product image, and display rack position displayed products corresponding to a product, a identification number of display rack or bundle-related search words, and may be configured to receive feedback information corresponding to the request from the store management server.

The input/output unit (350) may include a communication module (not shown in Figs.), and communicate with the store management server through a network. For example, a communication module (not shown in Figs.) may communicate with a management server using various service protocols, such as TCP/IP (Transmission Control Protocol/Internet Protocol), HTIP (HyperText Transfer Protocol), HTTPS (Hypertext Transfer Protocol over Secure Socket Layer), SOAP (Simple Object Access Protocol), XMLRPC (XML Remote Procedure Call), and etc.

The third indicate unit (360) displays shelf number, product name, total inventory, product image, and display stand position in which a product corresponding to the text or voice of the bundle-related search words input to the search word input unit (340) is displayed.

The speech to text unit (370) provides the voice information input from the search word input unit (340) to the third indicate unit (360) after converts into a bundle-related search word.

The Speech to Text unit (370) may include a program including a Speech to Text (Speech to Text: STT) engine for converting a voice into a text.

The speech to text unit (370) may include the following; Extraction unit (371) that extracts a code of the converted text (word) from a preset bundle word code table, and a text code array unit (372) that lists the extracted words as standard words, large, medium and small product like the pattern structure of bundle-related search words.

When the voice information input to the microphone (342) of the search word input unit (340) is “rice”, the speech to text unit (370) classifies the size of meaning between “word” and “word” into large, medium, and small after recognizing and separating “words” and “connecting language between words and “words” corresponding to voice information, and may extract the codes of the classified words from the bundled word code table described above, and provide the bundle-related search words listed in the pattern structure of the bundle-related search words to the input/output unit (350) and the third indicate unit (360).

The input/output unit (350) provides it to the third indicate unit (360) after receives the product position corresponding to the bundle-related search words and the shelf number on which the corresponding product is displayed from the store management server, and the third indicate unit (360) displays an image and a location of corresponding product, and a shelf number on which the corresponding product is displayed.

Product management terminal (300) according to an embodiment of the present invention may further include an artificial intelligence agent capable of providing a voice feedback of the voice query of the customer or manager.

The AI agent (380) is a dedicated program for providing a service of AI (Artificial Intelligence) base (E.g. speech recognition services, secretarial services, translation services, search services, multilingual language support services, product guidance service, product purchase proposal service and etc.), and may be executed by an existing general purpose processor (eg, a CPU) or a separate AI dedicated processor (eg, a CPU).

The AI agent may automatically or manually recognize various national languages, and provide location information of the corresponding product to search and extract.

The scan terminal of display product management (100) using the bundle-related search words according to an embodiment of the present invention may include a storage medium (not shown in Figs) that stores the bundle-related search words related to a product in a store.

The storage medium may be implemented as a memory or HDD (Hard Disk Drive). The storage unit may include a ROM, a RAM, and etc. for storing a program for performing an action of the scan terminal of display product management using the bundle-related search words, and may further include an EEROM (Electrically Erasable and Programmable ROM) or etc, storing various reference data.

The storage medium may store various UI specification information to be displayed on the third indicate unit. The UI specification may be a button size, position, color, and type (image, text, etc.) disposed UI window and in the UI window.

In some cases, the storage medium may store a UI component corresponding to a preset product or place category. The UI component may be various UI menus such as image items, text items, and link items constituting the UI screen.

The storage medium may further store image, video, graphic, voice, and category information of goods displayed in the store, and also search word information set to be associated with the category information.

Hereinafter, a store manager briefly describes a process of displaying a product on a shelf in a store by using the product management terminal of the present invention.

First, \textcircled{1} the store manager presses the scan action button (B1) and activate the action of the scan unit.

\textcircled{2} Scans the identification code of the product you want to display, and \textcircled{3} the process of scanning the identification code on the shelf repeat, and display the products on the corresponding shelf after pressed the reset button (B2), and reset the scan information of the scan unit.

When the identification code of the product and the display rack are scanned, shelf number scanned on the first indicate unit (320) and the product name and quantity on the second indicate unit (330) are displayed.

If the same product is on different shelf, the shelf number is indicated on the first indicate unit (320), and a warning sound is output on the alarm unit.

The product manager goes to the display rack indicated on the first indicate unit (320) and rearranges the specific product to be placed on the specific display rack, and repeat the above steps \textcircled{1} →\textcircled{2} →\textcircled{3}.

If the same product is displayed on different shelves, the store manager moves those products to the scanned shelf number.

If the product name on the second indicate unit (330) is not indicated or is indicated another product name, the store manager edits the product name using the microphone and touch keyboard of the search word input unit (340) after switching operation by pressing action change button (B3).

By scanning the identification code of the product, the store manager can easily identify the product name and the number of product inventory.

The store manager scans the product identification code for scraps, returns, and order quantities of product, and can be entered scraps, order, and return quantities of the product as voice or text using the microphone and touch keyboard.

—Text Input—

The store manager enters the word's code you want to find as a pattern of bundle-related search words using the bundle-related search words code provided by the store on the touch screen of the search word input unit (340) after switching the operation by pressing the action switch button (B3).

If the manager wants to find rice, manager enters a bundle-related search words related to rice on the touch keyboard of the search word input unit.

The manager displays the product corresponding to the bundle-related search words and the shelf number where the product is located to the third indicate unit.

—Voice Input—

The voice information of a bundle-related search word related to a product to be searched is input into a microphone of a search word input unit (340) after switching the operation by pressing the action switch button (B3).

The input voice information is provided to the speech to text unit (370), The speech to text unit (370) classifies the size of meaning between “word” and “word” into large, medium, and small after recognizing and separating “word” and “connection language between word and word” corresponding to the voice information, and may extract the code of the classified words in the above-described bundled word code table, and may provide the bundle-related search words listed in the pattern structure of the bundle-related search words to the input/output unit (350) and the third indicate unit (360).

The input/output unit (350) receives the product location corresponding to the bundle-related search words and the shelf number where the product from the store management server, and displays it to the third indicate unit (360).

The user may simply receive a product location to be searched and a shelf number on which the product is displayed using only a voice.

Store management server (400) holds various information in a database, and may be a device capable of providing various information in response to a request of a customer terminal (200). The store management server (400) may be implemented as an external server equipped separately from the store management terminal (300).

Store management server (400) is capable of delivering various information to the store management terminal (300) as communicate with a separate information providing server (not shown).

The product information may be in various forms according to the type of the product. For example, the product information may include various information; such as a name, code, type, size and color of product, and an address of a related server.

More specifically, the store management server (400) may include a product management unit (410), product search unit (420), store management unit (430), search keyword providing unit (440) and platform service unit (450).

The product management unit (410) registers, deletes and changes the product information input from the store management terminal, and classifies and manages the total quantity, inventory quantity, order quantity, return quantity, and damage amount for each product by the identification code of the product (1-dimensional barcode, 2-dimensional barcode).

The product search unit (420) provides a search result of searching for a display position, a shelf number, and a stock of a product corresponding to a bundled search keyword inputted from a store management terminal (300) and a store product search platform (10).

The product search unit (420) in order to build big data may refine unstructed data, structured data and semi-structured data contained within stored raw data, and can perform preprocessing including classification as metadata, and can analyze and perform data mining including preprocessed data. The store management server (300) visualizes and outputs the analyzed data. Data mining can perform classification to predict the class of new data or clustering, which group's data based on similarity without class information after exploring the inherent relationships between preprocessed data, and training on training data set for which the class is known. Various mining methods may exist, and may be mined differently according to types of collected and stored big data or types of queries to be requested later. The big data constructed in this way may have a verification process through artificial neural network deep learning or machine learning, etc.

Convolutional neural network can be used CNN (Convolutional neural network) structure, and CNN is suitable for image processing as network structure using the convolution layer, and may classify the image based on features in the image by entering image data.

Text mining is a technique aimed at extracting and processing useful information based on natural language processing technology from non/half-form text data. Through text mining technology, meaningful information is extracted from a large amount of text, and grasps the connection with other information, and find the category the text has, or can get more than just information retrieval. Using this, the secure transaction service according to an embodiment of the present invention analyze the identifier or natural language entered in the query, and can use large-capacity language resources, and statistical and regular algorithms to uncover information hidden in it.

The store management unit (430) manages the store area information including the location information of the product display rack in the store and the location information of the equipment in the store.

The search keyword providing unit (440) generates and provides a bundled search keyword of goods displayed in the store.

The platform service unit (450) supports a scan function of a store product search platform, a product information search interface, a registration management function of product information, a shopping route function, a product list sharing function, a duplicate product filtering function, and a history management function of product purchase.

The AI agent support unit (460) generates and provides a voice response to the voice query of the product management terminal (300). The AI agent support unit (460) is equipped with a dedicated program for providing a voice recognition service, a secretary service, a translation service, a search service, a multilingual language support service, product guidance service, product purchase proposal service and etc, and may be executed by an existing general purpose processor (For example, CPU, etc.) or a separate AI dedicated processor (For example, GPU, etc.). Various national languages can be recognized automatically or manually, and can provide after searched and extracted the location information of the product.

The AI agent support unit (460) performs keywords included in the preprocessed sentence, the morpheme information of word, sentence form of sentence, and analysis of user queries to provide answers using parsing trees, and as a result of the query analysis, and the intention of the user's utterance can be identified, and can generate a response to the user's utterance as the sentence level.

By using the display position and inventory management system of the goods using the bundle-related search words according to an embodiment of the present invention, store managers and customers can be provided with the product location displayed in the store and the shelf number where the product was displayed (location information) using bundle-related search words.

Using the same system, the store manager can systematically manage the products displayed in the store, and store customers can reduce the shopping time as receive shopping route of products to be purchased.

For example, “˜unit” of the term using in this invention may mean a unit including combination of one or two more of hardware, software, or firmware. For example, “˜unit” may be interchangeably used with terms such as unit, logic, logical block, component, or circuit. “˜unit” may be a minimum unit or their part of an integrally constructed part. “˜unit” may be a minimum unit or their part of performing one or more functions. “˜unit” may be implemented mechanically or electronically. “˜unit” may include at least one of the following to perform certain operations that are known or will be developed in the future; ASIC (Application-specific integrated circuit) chips, FPGAs (field-programmable gate arrays), or programmable-logic devices.

At least a part of an apparatus (eg, modules or functions thereof) or method (eg, operations) according to various embodiments may be implemented as a command stored in a computer-readable storage medium in the form of a program module. If a command is executed by a processor (e.g. a processor), one or more processors may perform a function corresponding to the command. For example, a computer-readable storage medium may be a memory.

The computer-readable recording medium may include the following. Hard disks, floppy disks, magnetic media (e.g. magnetic tape), optical media (e.g. CD-ROM (compact disc read only memory), DVD (digital versatile disc), magnetic-optical media (e.g. floptical disk), hardware device (e.g. ROM (read only memory)), RAM (random access memory), or flash memory), and etc. The program command may include machine language codes such as those produced by a compiler and high-level language codes that can be executed by a computer using an interpreter. The above-described hardware device may be configured to operate as one or more software modules to perform operations of various embodiments, and vice versa.

Around the outer case of the product display position and inventory management system (100) using the bundle-related search words may be coated with a perfume material having a sterilizing function, and a functional oil may be mixed with the perfume material.

The mixing ratio of the perfume material and the functional oil is 95 to 97% by weight of the perfume material and 3 to 5% by weight of the functional oil is mixed, and the functional oil is composed of 50% by weight of Cardamom oil and 50% by weight of Marigold oil.

It is preferable that 3 to 5% by weight of the functional oil is mixed with respect to the perfume material. When the mixing ratio of the functional oil is less than 3% by weight, the effect is insignificant. When the mixing ratio of the functional oil exceeds 3 to 5% by weight, the function is not greatly improved, while the manufacturing cost is greatly increased.

The main chemical components of cardamom oil are terpineol, cineol, etc., and have good effects on neuralgia, sterilization, antidepressant action, and stress relief.

Marigold oil is an oil extracted from marigold petals, and has excellent effects on treating skin diseases, sterilizing, relieving itchiness, clearing hair, and relieving tension.

Since the perfume material mixed with such functional oil is coated around the outer case of the product display position and inventory management system (100) using the bundle-related search words, and then the outer case is sterilized, and can obtain health-promoting effects such as recovering the fatigue of the worker.

On the outer surfaces of the first display unit (320), the second display unit (330), and the third display unit (360) may be applied with a contamination prevention coating layer made of a contamination prevention coating composition to effectively achieve the adhesion prevention and removal of contaminants.

The antifouling coating composition contains amphodiglycinate and sorbitol ester in a molar ratio of 1:0.01 to 1:2, and the total content of amphodiglycinate and sorbitol ester is 1 to 10% by weight based on the total aqueous solution.

Ampodiglycinate and sorbitol ester are preferably 1:0.01 to 1:2 as a molar ratio. If the molar ratio is out of the above range, there is a problem in that the coating film is removed as the applicability of the substrate decreases or moisture adsorption on the surface increases after application,

Ampodiglycinate and sorbitol ester are preferably 1 to 10% by weight in the aqueous solution of the entire composition. If it is less than 1% by weight, there is a problem that the applicability is deteriorated on the outer surfaces of the first indicate unit (320), the second indicate unit (330), and the third indicate unit (360). When it exceeds 10% by weight, crystal precipitation is likely to occur due to an increase in the coating film thickness.

As a method of applying the present antifouling coating composition to the outer surfaces of the first indicate unit (320), the second indicate unit (330), and the third indicate unit (360), it is preferable to apply it by a spray method. The final coating film thickness is preferably 500 to 2000 Å, more preferably 1000 to 2000 Å. When the thickness of the coating film is less than 500 Å, there is a problem of deterioration in the case of high-temperature heat treatment, and when it exceeds 2000 Å, crystal precipitation on the coated surface is liable to occur.

The present antifouling coating composition may be prepared by stirring after adding 0.1 mol of amphodiglycinate and 0.05 mol of sorbitol ester to 1000 ml of distilled water.

A specific embodiment has been described in the detailed description of the present disclosure. Person with ordinary knowledge in the art can perform various modifications without departing from the scope of this disclosure and in the technical field to which the present invention belongs. Therefore, the scope of rights according to the present disclosure should not be limited to the described implementation, and should be determined not only by the claims to be described later, but also by the scope of this patent claim and its equivalents. In addition, embodiments of these variations should not be individually understood from the technical idea or prospect of the present disclosure.

1. The display position and inventory management system of the product using a bundle-related search word includes the following. Customer terminal searching for goods displayed in the store using a store product search platform that uses bundle-related search words as product keywords; product management terminal to register, search and manage product's display location, shelf number, product name, total inventory for each product and product images in store based on product identification number and the bundle-related search words: and the product information in the store is converted into a database, and store management server providing at least one of the product's display position, shelf number, product name, total inventory for each product, and product images to the store product search platform and product management terminal corresponding to the search information entered in the store product search platform and product management terminal.

2. In claim 1, the product management terminal is a display location and inventory management system of the product using a bundle-related search words includes the following. A scan unit scanning product display rack or product identification number: first indicate unit for indicating the scanned identification number; second indicate unit for indicating the product name and quantity of goods registered with the scanned identification number; search word input unit to input related search words of product as text or voice; an input/output unit for requesting at least one or more information among the shelf number on which the product was displayed, product name, total inventory, product image and shelf location, and receiving feedback information from management server corresponding to an identification number or bundle-related search words; and third indicate unit for indicating shelf number, product name, total inventory, product images and a shelf location on which the product corresponding to the bundle-related search word inputted to the input unit is displayed.

3. In claim 2, includes the following. Scan action button that provides ON/OFF operation signal of the scan unit: reset button provides a reset signal; and action switch button for changing the action of the search word input unit to any one of the text, voice and manual modes. The reset signal may be a display position and inventory management system of product using a bundled-related search word that is a signal for resetting the operation of the first indicate unit, second indicate unit, third indicate unit and scan unit.

4. In claim 3, further includes speech to text unit with installed program including speech to text (STT) engine for converting speech information into text, and the speech to text unit may be a display location and inventory management system of the product using a bundle-related search word includes the following. Extraction unit for extracting the code of the converted text (word) from the already set code table of bundled word; and text code array unit that lists the extracted words in a pattern structure of bundle-related search words.

5. In claim 2, further includes an AI agent that provides feedback voices of voice queries from store customers or managers, and the A.I agent may be a display location and inventory management system of product using a bundle-related search word linked with a store management server that includes a multilingual language support function.

6. In claim 1, the store product search platform is a display location and inventory management system of product using a bundle-related search word includes the following. A scan interface for linked with the camera of the customer terminal and scanning the electronic identification code of the product; a product information search interface for searching for displayed products, product's display location and a shelf number in store using bundle-related search words; a product information registration management interface for generating and providing a product list script for registering and managing products list input by a customer; a shopping route interface that creates and displays the shortest-distance shopping route line of the store to the customer based on the product list registered in the product information registration management interface.

7. In claim 6, the product information registration management interface is a display location and inventory management system of product using a bundle-related search word includes the following. Product list sharing function for sharing the product list with an acquaintance terminal, filtering function for summing the acquaintance product list of the acquaintance terminal with the product list and filtering duplicate products among the shared product list

8. In claim 7, the product information registration management interface is a display location and inventory management system of product using a bundle-related search word includes the following. Deducting products scanned from the scan interface among products in the registered product list from the product list.

9. In claim 6, the product information search interface is a display location and inventory management system of product using a bundle-related search word includes the following. Providing the bundle-related search words to an organized bundle-related search table corresponding to products displayed in the store.

10. In claim 8, the store product search platform is a display location and inventory management system of product using a bundle-related search word includes the following. Product purchase history management interface that records and stores purchase history of products included in the registered product list and purchase history of purchased products

11. In claim 1, the store management server is a display location and inventory management system of product using a bundle-related search word includes the following. Product management unit that registers, deletes and changes the product information input in the store management terminal, and manages total quantity, inventory, order, return, damage by each product; the product search unit providing a search result of searching for a display location, a shelf number, and a stock of product corresponding to a bundled search keyword entered in the store management terminal and the store product search platform; the store management unit that manages store area information including location information of product display rack and equipment in the store; the search keyword providing unit for generating and providing a bundled search keyword of products displayed in a store; and platform service unit that supports the scanning function of the store product search platform, product information search interface, product information registration management function, shopping route function, product list sharing function, duplicate product filtering function, and product purchase history management function.

12. In claim 1, the bundle-related search word may be a display location and inventory management system of product using a bundle-related search word includes the following. A first search factor that bind with the origin (country) of the product to be searched, the product name used in the origin and standard word; and second search factor for classifying into any one of the large, medium, and small categories of the product.
